(19) United States
(12) Patent Application Publication
(10) Pub. No.: US 2011/0062790 A1
(43) Pub. Date: Mar. 17, 2011

(54) SYSTEM FOR WIRELESSLY POWERING THREE-DIMENSION GLASSES AND WIRELESSLY POWERED 3D GLASSES

(76) Inventors: Ammak Kouki, Montreal (CA); Jin Pin Ma, Montreal (CA)

(21) Appl. No.: 12/880,233

(22) Filed: Sep. 13, 2010

Related U.S. Application Data
(60) Provisional application No. 61/241,702, filed on Sep. 11, 2009.

(51) Int. Cl. H02J 17/00

(52) U.S. Cl. 307/104

(57) ABSTRACT

Some aspects are directed to a system for wirelessly powering a pair of three-dimension (3D) glasses, and to a wirelessly powered 3D glasses. The system uses a powering device for generating and transmitting a wireless power signal, and a rectenna integrated within the 3D glasses for receiving the wireless power signal. The rectenna converts the wireless power signal into a Direct Current for powering the 3D glasses. The 3D glasses comprises a frame, a pair of Liquid Crystal Shutters supported by the frame, and a rectenna for receiving a wireless power signal and transforming the wireless power signal into a direct current signal for powering the 3D glasses.

### RELATED APPLICATIONS

This application claims the benefit of U.S. Provisional Patent Ser. No. 61/241,702, filed Sep. 11, 2009, the entire contents of which are hereby incorporated by reference herein for all purposes.

### TECHNICAL FIELD

Embodiments herein relate to a system for wirelessly powering and controlling a pair of shutter glasses for viewing three-dimensional images, films, games and various video content.

### INTRODUCTION

Stereoscopy is a technique creating an illusion of depth out of two-dimensional images, also called “third dimension” or 3D. The illusion of third dimension is created by taking images at different angles, and presenting those images independently to each eye. Generally, there are two stereoscopic techniques: a passive configuration and an active configuration.

The passive configuration uses linearly or circularly polarized three-dimensional (3D) glasses to create the illusion of 3D images by restricting the light that reaches each eye. To present a stereoscopic movie, two images are superimposed onto a screen using orthogonal polarizing filters. Projecting two superimposed images simultaneously requires two projectors, which results in higher costs. Because of the prohibitive costs, the passive configuration is not widely used for 3D home theater systems.

The active configuration uses Liquid Crystal Shutter (LCS) glasses and alternates the right and left eye shutters in a rapid succession so as to present each of the images in successively to a corresponding eye. Generally, the active configuration provides a higher resolution and a wider viewing angle than the passive configuration. Although active 3D glasses are more complex and expensive than passive 3D glasses, the overall cost of a 3D imaging system based on the active configuration is usually less expensive as only one projector is required. Furthermore, active configuration systems can be used with standard computer and TV screens. Thus, the active 3D glasses and corresponding 3D imaging systems are more attractive for 3D home theater systems.

Typical 3D glasses are powered by means of batteries or a wired DC power supply. However, such powering means are inconvenient for users of 3D glasses. The batteries need to be replaced or charged at certain intervals, and replacement of batteries or charging while viewing a 3D movie is not particularly convenient. Use of a wired DC power supply is also not generally desirable, as it requires proximity to an electric outlet. Furthermore, the electric wire has a non-negligible weight which tends to make wearing 3D glasses less comfortable.

The inventors have therefore identified a need for a 3D glasses and systems for 3D imaging that attempt to alleviate at least some such power problems.

### BRIEF DESCRIPTION OF THE DRAWINGS

In the present description, the following drawings are used to describe and exemplify the present system and 3D glasses, where like numerals denote like parts.

FIG. 1 is an exemplary schematic representation of a rectenna.

FIGS. 2A to 2E are representations of 3D glasses and variants of antennas.

FIG. 3A is a schematic representation of a system for wirelessly powering 3D glasses in accordance with an infrared control scheme.

FIG. 3B is a schematic representation of a system for wirelessly powering 3D glasses in accordance with a duplex control scheme.

FIG. 3C is a schematic representation of a system for wirelessly powering and controlling 3D glasses with two rectennas.

FIG. 4 is a table defining transmitter and receiver requirements for different controlling schemes.

FIG. 5 is an exemplary schematic representation of a rectenna including a duplexer.

### DETAILED DESCRIPTION

The present embodiments propose a system and 3D glasses that tend to alleviate the problems encountered with current powering means. More particularly, the present system and 3D glasses describe wirelessly powering 3D glasses, and wirelessly powering and controlling 3D glasses.

To this end, one present system comprises a wireless powering device and a rectenna. The wireless powering device generates and transmits a wireless power signal, and the rectenna is integrated within the 3D glasses for receiving the wireless power signal and converting it into direct current or “DC” for powering the 3D glasses.

In another aspect, the powering device further generates and transmits a wireless power and control signal, and the rectenna receives the wireless control and power signal and converts it into direct current for powering and controlling the 3D glasses.

In another aspect, the present 3D glasses comprise a frame, a pair of Liquid Crystal Shutters (LCSs) supported by the frame, and a rectenna for receiving a wireless power signal and transforming the wireless power signal into direct current for powering the 3D glasses.

### Wireless Power Transmission

In the past few decades, wireless and contactless powering and wireless power transmission have been introduced. Applications for radio and microwave power transmission (hereinafter referred as wireless power transmission) have been proposed for helicopter powering, solar-powered satellite-to-ground transmissions, inter-satellite power transmissions including utility power satellites, mechanical actuators for space-based telescopes, small DC motor driving, short range wireless power transfer as well as low-power near-field interrogation with RFID tags, and medium- and low-powering density powering of low-power sensors.

Wireless power transmission is accomplished by receiving incident waves (wireless power) by means of an antenna and rectifying the received incident waves to output a corresponding direct current (DC) voltage. Integration of a receiving antenna and a rectifier is referred to as a “rectenna”.

### Rectenna

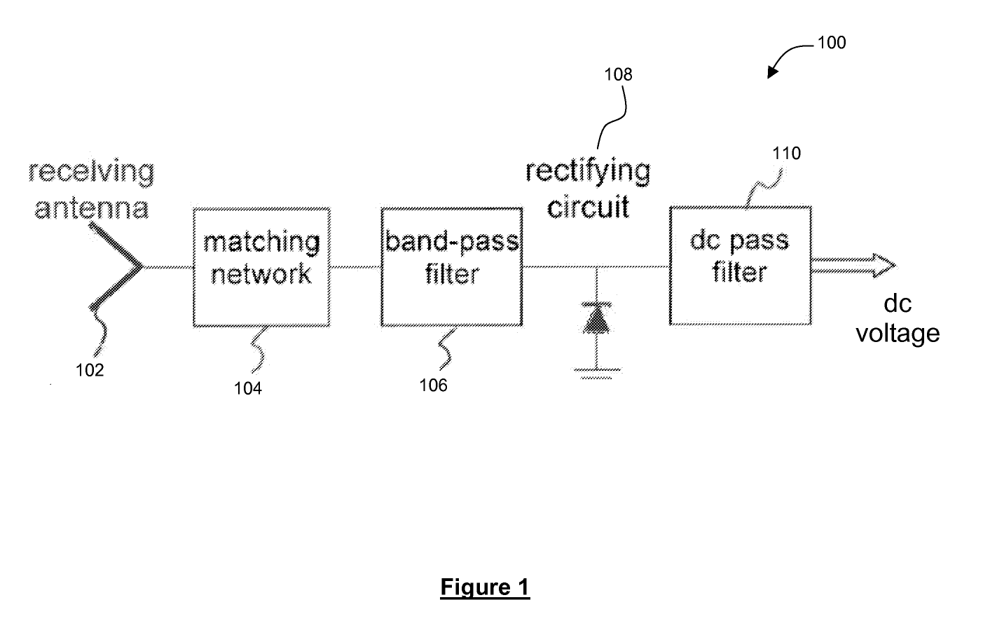

Reference is made to FIG. 1, which depicts an exemplary schematic representation of a rectenna. This exemplary rectenna 100 includes an antenna 102, a matching network 104, a band-pass filter 106, a rectifying circuit 108 and a DC pass filter 110. The antenna 102 receives a wireless power signal and the rectifying circuit converts the received wireless power signal to direct current electric power (DC voltage).

The received wireless power signal is attenuated by free-space path loss, and the amount of power that can be transmitted wirelessly is limited for security and safety reasons by regulations, such as Safety Codes on limits for human exposure to radiofrequency (RF) fields.

Other similar designs of rectennas 100, including at least an antenna and one or several rectifying circuits could be used without departing from the scope of the present embodiments.

The rectenna 100 is to be installed on 3D glasses. For comfort and aesthetic reasons, the 3D glasses are normally of a small dimension or size. In turn, this normally means that the antenna 102 of the rectenna 100 will be of a small dimension or size. This results in a small physical antenna area, which favors the choice of higher frequency for more efficient power collection.

The band-pass filter 106 (inserted between the antenna 102 and the rectifying circuit 108 and depicted by a single diode on FIG. 1) is designed so that a fundamental frequency or narrow band of frequencies is allowed to pass, while other frequencies received by the antenna 102 are rejected effectively.

The band-pass filter 106 further suppresses a significant portion of higher order harmonics generated by the rectifying circuit 108. The rectifying circuit 108 may consist of a single diode shunt or any other similar component adapted to passively convert an alternating signal into DC voltage.

In some embodiments, power conversion efficiency may be maximized by substantially confining all higher order harmonics between the band-pass 106 filter and the DC pass filter 110, using an efficient diode 108 and matching the diode's input impedance to the antenna 102 impedance by means of the matching network 104. The DC pass filter 110 blocks remaining fundamental and harmonic frequencies, and thus ensures that no oscillating signal exits the DC pass filter, and only a DC voltage is outputted. The power conversion efficiency of the diode 108 changes as the operating power level changes. Thus the power conversion efficiency of the rectenna 100 varies with the received wireless power signal.

Although not shown in FIG. 1, in some embodiments the rectenna 100 could further include two parallel band-pass filters 106, two rectifying circuits 108 and two DC pass filters 110 to simultaneously receive and convert wireless power signals of different frequencies. Each frequency of the wireless power signal could then power and control one of the Liquid Crystal Shutters (LCSs) of the 3D glasses.

Other variants could further be applied to the rectenna 100. For example, two polarizations of the wireless power signal could each correspond to one of the LCSs, and the rectenna 100 could be adapted to separate the polarized components of the wireless power signal to power a corresponding LCS.

Thus, the rectenna 100 is generally not limited to receiving a wireless power signal, but may also be adapted to receive a wireless power and control signal.

Many variants may be applied to the rectenna 100 for optimization purposes. Those skilled in the art of Radio Frequencies and Radio Frequency circuit designs will note that the rectenna of FIG. 1 is a simplified schematic circuit to which many improvements can be introduced without departing from the scope of the present embodiments.

### 3D Glasses

As the 3D glasses must normally have a shape and size that are ergonomic and aesthetic, integration of the rectenna 100, and more particularly the antenna 102 of the rectenna, within a frame of the 3D glasses requires particular consideration. To increase the amount of wireless power signal or wireless power and control signal, the antenna 102 will be preferably integrated in the frame surrounding the LCSs.

Such integration is not essential for proper functioning of the 3D glasses, but is recognized as having many advantages. By integrating the antenna 102 around the LCSs, it is possible to be in a quasi-line of sight with the transmitted wireless power signal or wireless power and control signal. Such quasi line of sight tends to increase the power of the received signal, and thus enables generation of more DC voltage. As the received signal is of better quality with less loss, it further allows for reduced transmission power of the wireless power signal or wireless power and control signal. Such advantages are interesting to ensure sufficient wireless power transmission with lower transmission power.

Although integration of the antenna 102 around the LCSs has been described, several other alternatives could be considered. The antenna 102 could be added to any portion of the frame of the 3D glasses, or could further be located outside of the frame and be a separate component to the frame.

Various types of technologies, materials, substrates, shapes and designs may be used to implement the antenna 102 and the rectenna 100 on the 3D glasses. For example, low-temperature co-fired ceramic (LTCC) technology, used for radio and microwave applications may be used. Three-dimensional (3-D) integration capabilities of LTCC enable size-reduction and low-cost design. Another advantage of LTCC technology resides in its low dielectric loss tangent, which makes it an interesting choice for medium and high frequency applications.

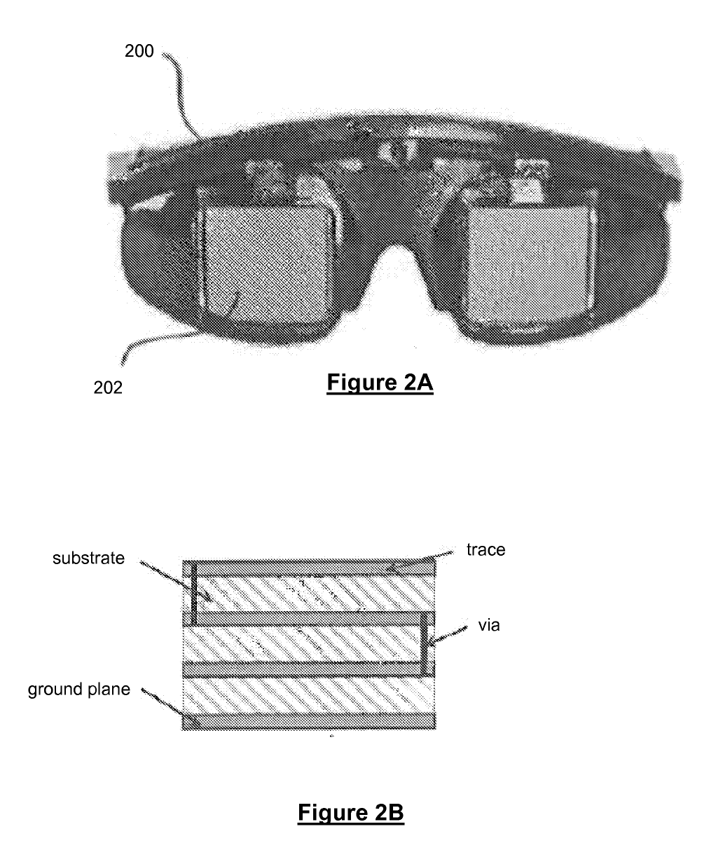

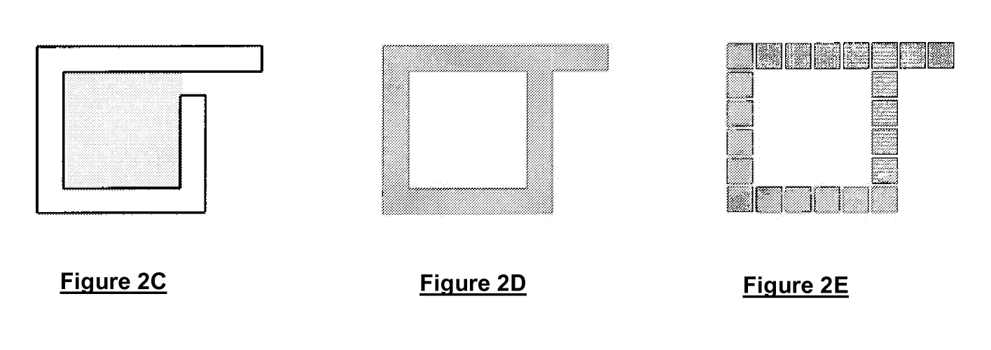

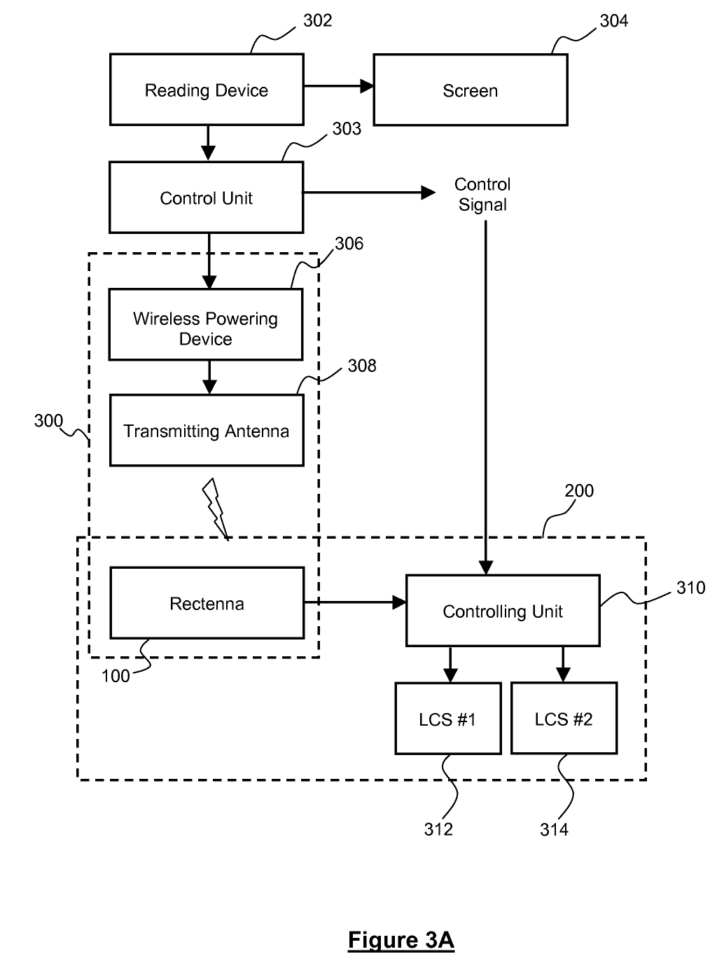

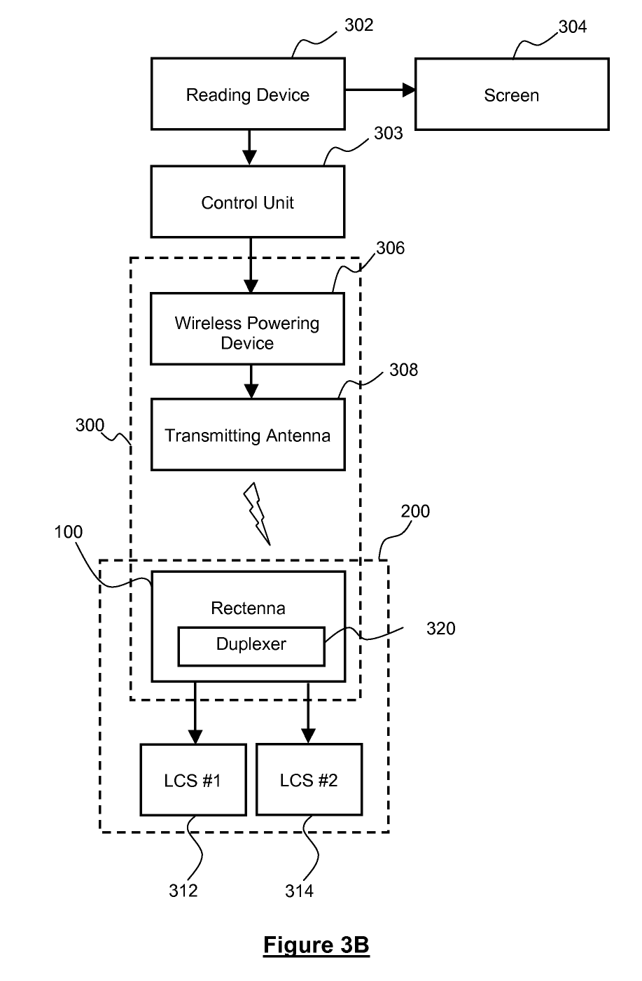

Reference is now made to FIG. 2A, which shows the 3D glasses 200. As can be appreciated, the 3D glasses 200 are designed so as to have a shape to be comfortably worn by a viewer, without being too bulky or heavy. The rectenna 100 is incorporated to a frame 202 of the 3D glasses 200.

FIG. 2B depicts an exemplary side view of a multi-layered LTCC-based structure. FIGS. 2C to 2E depict examples of rectenna 100 and layers to be implemented in the frame 202. More particularly, FIG. 2C corresponds to a top view of a square loop antenna. FIG. 2D depicts a solid ring ground plane, while FIG. 2E represents an exemplary meshed ring ground plane.

Depending on the control scheme selected, one or two antennas 102 and one or two rectennas 100 may be integrated in the frame 202 of the 3D glasses to either power or power and control the LCSs.

### System for Wirelessly Powering 3D Glasses

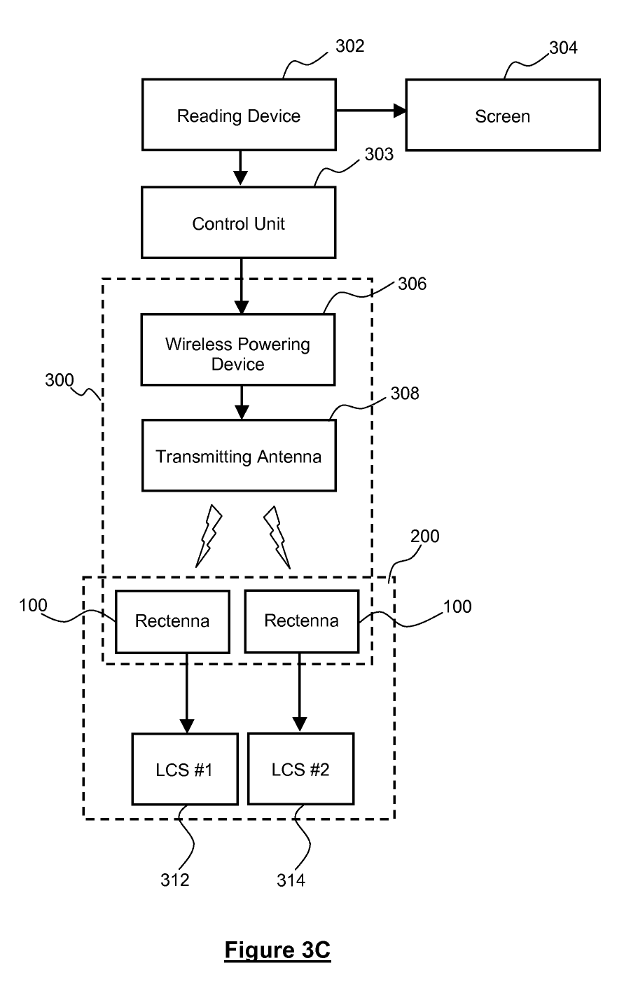

Reference is concurrently made to FIGS. 1, 2 and 3A, where FIG. 3A is a schematic representation of a system for wirelessly powering 3D glasses in accordance with an infrared control scheme. The system 300 comprises a wireless powering device 306, a transmitting antenna 308 and wirelessly powered 3D glasses 200. The system 300 is adapted to be used with a 3D reading device 302, a control unit 303 and a screen 304.

The 3D glasses 200 include a pair of LCSs 312 and 314, which are to be actuated in synchronicity with images displayed on the screen 304. The synchronizing information to be applied by the 3D glasses 200 to synchronize with images presented on the screen 304 may be stored or otherwise provided using the same medium as the images to which it is to be applied. For movies, for example, the synchronization information may be extracted by any of the following reading devices 302: an active 3D home theater amplifier, an active 3D DVD reader, a 3D active Blu-ray reader, a video synchronization control box, or any other type of device adapted to extract synchronization information from a 3D movie or image to be presented.

Examples of mediums on which the 3D image(s) or movie and synchronization information may be stored include: Digital Video Disks, Blu-Ray disks, a computer, or any other type of medium on which three-dimensional images, and movies may be stored.

The reading device 302 outputs a signal to be ultimately displayed on the screen 304. The screen 304 may consist of a plasma screen, a Liquid Crystal Display, a Light Emitting Diode screen, a projected image from a video projector or any other type of screen having sufficient definition and refresh rate to support three-dimensional images and movies.

The control unit 303 may be integrated within the reading device 302, or be in addition thereto. The control unit 303 receives the synchronization information and generates therefrom a control signal to be sent to the 3D glasses 200 by wire, infrared or wirelessly.

The 3D glasses 200 receive the control signal and accordingly control shuttering of the LCSs 312 and 314 following the control scheme of images presented on the screen 304. Thus each eye sees only the appropriate image, and 3D effect can be achieved. More particularly in the present aspect, the control signal is an infrared signal emitted by the control unit 303 and received by a controlling unit 310 of the 3D glasses 200, which accordingly actuates each one of the pair of LCSs 312 and 314.

Instead of relying on batteries or a DC power adapter, the present 3D glasses 200 use a wireless power signal and a rectenna 100. The control unit 303 further outputs a signal to actuate the wireless powering device 306 when a 3D image is to be presented on the screen, and deactivate the wireless powering device 306 when reading of the 3D images or movies is interrupted.

When actuated, the wireless powering device 306 generates a wireless power signal transmitted to the 3D glasses 200 by means of the transmitting antenna 308, and received by the rectenna 100. The rectenna 100 receives the wireless power signal and transforms it into a DC voltage to power the 3D glasses 200.

The wireless powering device 306 and transmitting antenna 308 may operate within various frequency bands, such as Industrial, Scientific and Medical (ISM) frequency bands, 900 MHz, 2.4 GHz and 5.8 GHz. The selected frequency band depends on propagation properties, the rectenna antenna 102 size and gain, and safety regulations for radio frequencies power levels.

Reference is now made concurrently to FIGS. 2 and 3B and 5, where FIG. 3B is a schematic representation of a system for wirelessly powering 3D glasses in accordance with a duplex control scheme, and FIG. 5 is an exemplary schematic representation of a rectenna comprising a duplexer. In this aspect, the two LCSs 312 and 314 function using the same polarization, but a distinct frequency is assigned to each LCS.

When a first LCS 312 is to be activated, the wireless power signal is generated on the corresponding frequency of the LCS to be activated. When the other LCS 314 is to be activated, the wireless power signal is generated on the other frequency. In this aspect, the rectenna 100 further comprises a duplexer 320 with two parallel circuits, where each circuit corresponds to one specific frequency, as shown on FIG. 5.

Thus, the control unit 303 communicates solely with the wireless power device 306, which generates a wireless power. The wireless power is then provided to the transmitting antenna 308, which wirelessly transmits the wireless power signal. The wireless power signal is received by the rectenna 100. Instead of a single band-pass filter as shown on FIG. 1, the duplexer 320 includes two band-pass filters 106a and 106b, each corresponding to one of the two frequencies. Thus depending on the frequency received, a corresponding path of the rectenna will be functional. Each path of the rectenna 100 powers one of the two LCS 312 or 314.

Reference is now made to FIGS. 1, 2 and 3C, which show a schematic representation of a system for wirelessly powering and controlling 3D glasses with two rectennas. In this particular aspect, the control unit 303, the wireless power device 306 and the transmitting antenna 308 function similarly to the previously described aspect. In this aspect, however, the 3D glasses 200 however include two independent rectennas 100. Each rectenna 100 powers a corresponding LCS 312 and 314. The wireless power device 306, the transmitting antenna 308 and the rectennas 100 may use different frequencies, with each rectenna's antenna resonating at a different frequency, or different polarizations at the same frequency or a combination of both to power each of the LCS 312 and 314.

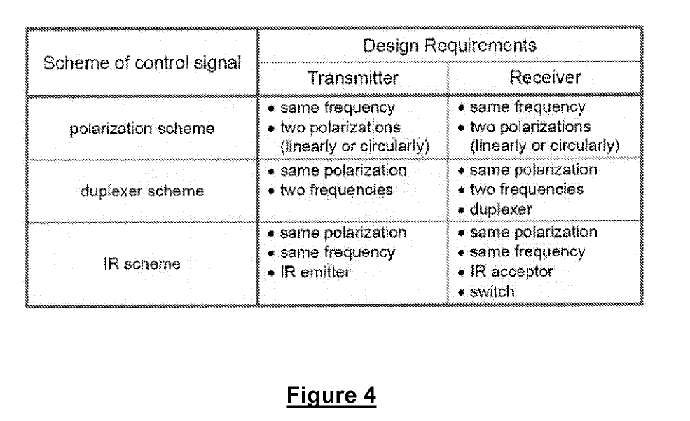

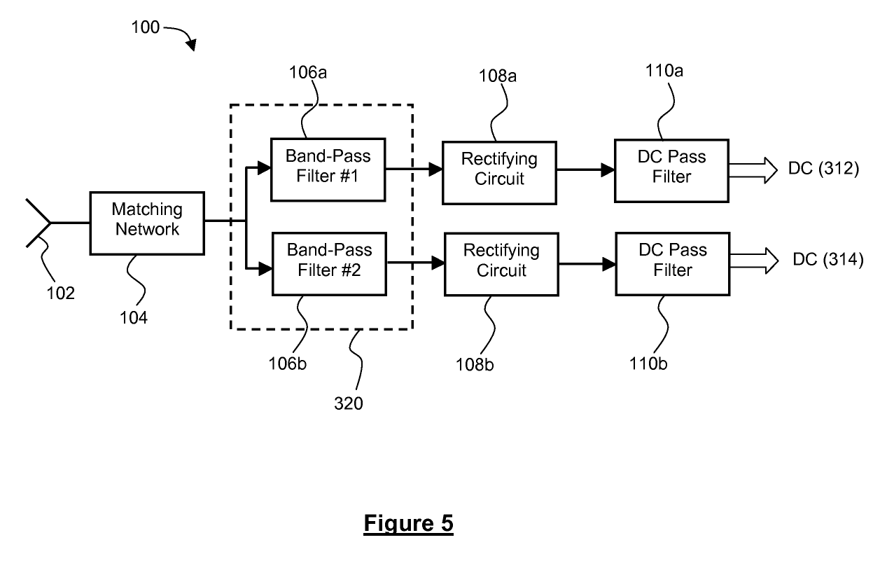

Reference is made to FIG. 4, which provides a table defining transmitter (control unit 303) and receiver requirements (controlling unit 310) for different controlling schemes. Transmitter and receiver requirements depend on the type of control scheme used to present the image(s) and movies.

Three examples of control schemes are provided in FIG. 4. For each control scheme, the main corresponding transmitter and receiver requirements are provided. The polarization scheme uses a single frequency for controlling both LCSs, with different polarization states, i.e. horizontal and vertical polarizations or right hand and left hand circular polarizations, to turn on and off the LCSs in alternance.

The duplexer scheme uses two separate frequencies at the transmitter and a duplexer at the receiver, where each frequency controls one LCS.

The infrared (IR) control scheme uses an IR emitter in the transmitter and an IR sensor in the receiver. The IR emitter is connected to the control unit 303 while the IR sensor controls a controlling unit 310 to turn on/off proper LCS of the 3D glasses. Other variants and combinations based on the described embodiments can be anticipated by those skilled in the art.

The present invention has been described by way of preferred embodiments. It should be clear to those skilled in the art that the described preferred embodiments are for exemplary purposes only, and should not be interpreted to limit the scope of the present invention. The 3D glasses and systems as described in the description of preferred embodiments can be modified without departing from the scope of the present invention. The scope of the present invention should be defined by reference to the appended claims, which delimit the protection sought

1. A system for wirelessly powering a pair of three-dimension liquid crystal shutter (3D LCS) glasses, the system comprising:
a powering device for generating and transmitting a wireless power signal;
at least one rectenna integrated within the 3D glasses for receiving the wireless power signal, the at least one rectenna converting the wireless power signal into a direct current for powering the 3D glasses;
a control unit for extracting from a storage medium a control signal for the 3D glasses, the control unit operable to transmit the control signal to the 3D glasses;
wherein the at least one rectenna comprises an antenna, and a rectifying circuit, and the antenna of the at least one rectenna is located around at least one of the liquid crystal shutters of the 3D glasses, and
wherein the at least one rectenna further comprises an impedance matching network, a band-pass filter and a DC pass filter.

2. The system of claim 1, wherein the rectifying circuit is a single diode shunt.

3. The system of claim 1, wherein the at least one rectenna is implemented in low-temperature co-fired ceramic.

4. A pair of three-dimension liquid crystal shutter (3D) glasses comprising:
a frame;
a pair of liquid crystal shutters supported by the frame; and
at least one rectenna for receiving a wireless power signal and transforming the wireless power signal into a direct current signal for powering the liquid crystal shutters.

5. The pair of 3D glasses of claim 4, further comprising a controlling unit for receiving a control signal and controlling powering of the pair of liquid crystal shutters accordingly.

6. The pair of 3D glasses of claim 5, wherein the at least one rectenna comprises an antenna and a rectifying circuit.

7. The pair of 3D glasses of claim 6, wherein the rectifying circuit is a single diode shunt.

8. The pair of 3D glasses of claim 6, wherein the antenna of the at least one rectenna is located around at least one of the liquid crystal shutters.

9. The pair of 3D glasses of claim 5, further comprising an infrared receiver for receiving the control signal and a switch for controlling the liquid crystal shutters in accordance with the received infrared control signal.

10. The pair of 3D glasses of claim 6, wherein the at least one rectenna is implemented in low-temperature co-fired ceramic within the frame.

11. A system for wirelessly powering a pair of three-dimension liquid crystal shutter (3D LCS) glasses, the system comprising:
a powering device for generating and transmitting a wireless power signal; and
at least one rectenna integrated within the 3D glasses for receiving the wireless power signal, the at least one rectenna converting the wireless power signal into a Direct Current for powering the 3D glasses.

12. The system of claim 11, wherein the at least one rectenna comprises an antenna, and a rectifying circuit.

13. The system of claim 12, wherein the rectifying circuit is a single diode shunt.

14. The system of claim 12, wherein the antenna of the at least one rectenna is located around at least one of the liquid crystal shutters of the 3D glasses.

15. The system of claim 12, wherein the at least one rectenna is implemented in low-temperature co-fired ceramic.

16. The system of claim 11, further comprising a control unit for extracting from a storage medium a control signal for the 3D glasses.

17. The system of claim 16, wherein the control unit transmits the control signal to the 3D glasses in any of the following methods: wireless, wired, infrared.

18. The system of claim 11, further comprising a reading device for reading 3D images from a storage medium and extracting therefrom a control signal.

19. The system of claim 12, wherein the at least one rectenna further comprises an impedance matching network, a band-pass filter and a DC pass filter.
